(19) United States
(12) Patent Application Publication
(10) Pub. No.: US 2008/0071924 A1
(43) Pub. Date: Mar. 20, 2008

(54) Interrupting Transmission Of Low Priority Ethernet Packets

(76) Inventor: Murali S. Chilukoor, Bangalore (IN)

Correspondence Address: Grossman Tucker Perreault & Pfleger;c/o Portfollo Ip, P O Box 52050, Minneapolis, MN, 55402, US

(21) Appl. No.: 10/547,021

(22) PCT Filed: Apr. 21, 2005
(86) PCT No.: PCT/IB05/01095

§ 371 Date: Aug. 24, 2005

(51) Int. Cl. G06F 15/173

(52) U.S. Cl. 709/240; 709/238

(57) ABSTRACT

A method according to one embodiment may include transmitting a first segment of a first packet. The first packet may have a first priority and be compliant with an Ethernet communication protocol. The method may further include interrupting transmitting of the first packet upon notice of a second packet for transmission. The second packet may have a second priority higher than the first priority, and the second packet may also be compliant with the Ethernet communication protocol. The method may further include transmitting an entirety of the second packet, and transmitting a second segment of the first packet after transmission of the entirety of the second packet. Of course, many alternatives, variations, and modifications are possible without departing from this embodiment.

### FIELD

This disclosure relates to interrupting transmission of low priority Ethernet packets.

### BACKGROUND

A variety of computer nodes may communicate with each other via one or more communication networks. Each computer node may function as a transmitting (source) and receiving (destination) device in order to exchange data and/or commands with each other using one or more of a variety of communication protocols. One such communication protocol is an Ethernet communication protocol. The Ethernet protocol may comply or be compatible with the Ethernet standard published by the Institute of Electrical and Electronics Engineers (IEEE) titled “IEEE 802.3 Standard”, published in March, 2002 and/or later versions of this standard. The transmitting node, in compliance with the Ethernet communication protocol, may parse data into packets for more efficient routing. The size of Ethernet packets may range from 64 bytes to 1,518 bytes. With jumbo packet support, the maximum sized Ethernet packet may be as high as 9 kilobytes.

Such variable sized Ethernet packets may provide for efficient transfer of large amounts of data. However, such variable sized Ethernet packets can lead to degradation in the quality of service for latency sensitive traffic such as real time voice traffic. Such degradation in quality of service may be caused by end-to-end latency in excess of acceptable levels for high priority packets, and excessive delay in signaling a congestion condition event. For example, a larger sized low priority Ethernet packet may have just started to be transmitted to a receiving node. A high priority packet may then become ready for transmission from the same transmitting node. A conventional transmitting node may complete transmission of the entirety of the low priority Ethernet packet before transmitting the high priority packet. Since the low priority packet may be large, e.g., 1,518 bytes and higher, this may lead to excessive delays. In one instance, the high priority packet may be a pause control packet generated in response to a congestion condition. A conventional node may complete transmission of the low priority packet before transmitting the pause control packet. As such, this may lead to an excessive delay in signaling the congestion condition which may render the congestion control ineffective in some instances.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating another system embodiment;

FIG. 3 is a diagram illustrating in greater detail the integrated circuits of FIGS. 1 and 2;

FIG. 4 is a diagram illustrating an interruption of transmission of a low priority packet to transmit one or more high priority packets while the low priority packet is interrupted;

FIG. 5 is a diagram illustrating multiple interruptions of transmission of a low priority packet to transmit one or more high priority packets while the low priority packet is interrupted;

FIG. 6 is a diagram of a packet illustrating a virtual local access network tag to define a priority level of the packet; and

FIG. 7 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

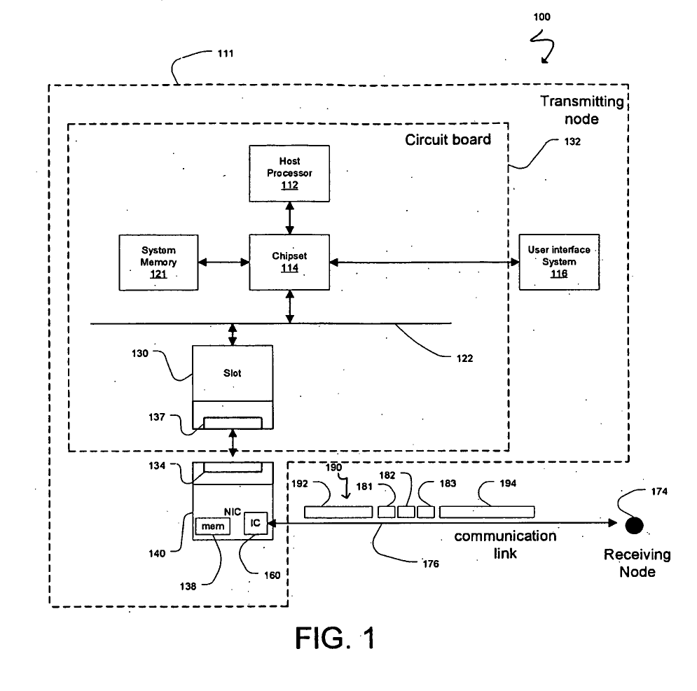

FIG. 1 illustrates a system embodiment 100 of the claimed subject matter. In general, a transmitting node 111 and receiving node 174 may communicate using the Ethernet communication protocol via a communication link 176. The transmitting node 111 may transmit a low priority packet 190 to the receiving node if no high priority packet is available for transmission. During transmission of the low priority packet 190, the transmitting node 111 may transmit a first segment 192 of the low priority packet 190 before one or more high priority packets 181, 182, 183 may become available for transmission. The transmitting node 111 may then interrupt transmission of the low priority packet 190 and transmit the available high priority packets 181, 182, 183. Once all the available high priority packets 181, 182, 183 are transmitted in their entirety, the transmitting node 111 may continue with transmission of the low priority packet 190 by transmitting the remaining segment 194 of that packet 190. All of the packets 190, 181, 182, and 183 may comply with the Ethernet communication protocol.

The transmitting node 111 and receiving node 174 may include data terminal equipment and data communication equipment. Data terminal equipment may include devices that are either the source or destination of packets including, but not limited to, personal computers, workstations, servers, and print servers that as a group may also be referred to as stations. Data communication equipment may include stand alone devices that receive and forward packets across a network including, but not limited to, switches, routers, and repeaters. The transmitting node 111 and receiving node 174 are labeled as such for clarity of explanation, although each node 111 and 178 may both transmit and receive packets.

Additional data terminal equipment may include an Advanced Telecommunications Computing Architecture (Advanced TCA or ATCA) chassis, complying with or compatible with PCI Industrial Computer Manufacturers Group (PCIMG) rev. 3.0, Advanced Telecommunications Computing Architecture (ATCA), published Dec. 30, 2002 having circuit boards, which may also be referred to as ATCA blades, disposed within the chassis. Each ATCA blade may be configured for bidirectional communication with a switch that may be coupled to the backplane of the ATCA chassis.

In the embodiment of FIG. 1, the transmitting node 111 may include a host processor 112, a bus 122, a user interface system 116, a chipset 114, system memory 121, a card slot 130, and a network interface card (NIC) 140. The host processor 112 may include one or more processors known in the art such as an Intel ® Pentium ® IV processor commercially available from the Assignee of the subject application. The bus 122 may include various bus types to transfer data and commands. For instance, the bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 122 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface system 116 may include one or more devices for a human user to input commands and/or data and/or to monitor the system, such as, for example, a keyboard, pointing device, and/or video display. The chipset 114 may include a host bridge/hub system (not shown) that couples the processor 112, system memory 121, and user interface system 116 to each other and to the bus 122. The chipset 114 may include one or more integrated circuit chips, such as those selected from integrated circuit chipsets commercially available from the Assignee of the subject application (e.g., graphics memory and I/O controller hub chipsets), although other integrated circuit chips may also, or alternatively be used.

When the NIC 140 is properly inserted into the slot 130, connectors 134 and 137 may become electrically and mechanically coupled to each other. When connectors 134 and 137 are so coupled to each other, the NIC 140 may be electrically coupled to the bus 122 and may exchange data and/or commands with system memory 121, host processor 112, and/or user interface system 116 via the bus 122 and chipset 114. Alternatively, without departing from this embodiment, the operative circuitry of the NIC 140 may be included in other structures, systems, and/or devices. These other structures, systems, and/or devices may be, for example, in the circuit board 132 (e.g., a motherboard in one embodiment) and coupled to the bus 122. These other structures, systems, and/or devices may also be, for example, comprised in chipset 114.

The NIC 140 may include an integrated circuit (IC) 160. As used herein, an “integrated circuit” or IC means a semiconductor device and/or microelectronic device, such as, for example, a semiconductor integrated circuit chip. The NIC 140 may also include memory 138. Memory 138 may comprises one or more of the following types of memory: semiconductor firmware memory, programmable memory, non-volatile memory, read only memory, electrically programmable memory, random access memory, and/or flash memory. Either additionally or alternatively, memory 138 may comprise other and/or later-developed types of machine-readable memory.

Machine readable firmware program instruction may be stored in memory 138. These instructions may be accessed and executed by the IC 160. When executed by the IC 160, these instructions may result in the IC 160 performing the operations described herein as being performed by the IC 160.

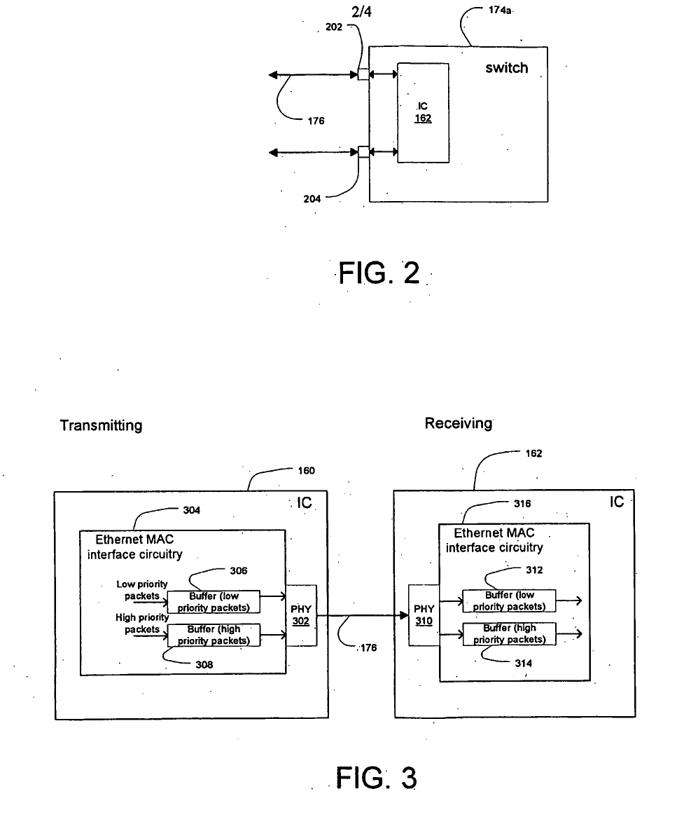

FIG. 2 illustrates another system embodiment where the receiving node 174 of FIG. 1 may be a switch 174a. The switch 174a may receive and forward packets to other nodes that it accepts at ports 202 and 204. Port 202 may be coupled to communication link 176 to facilitate communication with node 111. The switch 174a may also comprise an IC 162.

FIG. 3 is a diagram illustrating in greater detail portions of the integrated circuits 160 and 162 of FIGS. 1 and 2. The IC 160 may include Ethernet media access control (MAC) interface circuitry 304 and physical interface circuitry (PHY) 302. As used herein, “circuitry” may comprise, for example, singly or in any combination, hardwired circuitry, programmable circuitry, state machine circuitry, and/or firmware that stores instructions executed by programmable circuitry. The IC 160 and also the IC 162 may include a host of other circuitry (e.g., processor circuitry, memory control circuitry, a processor bus, memory, and host interface circuitry) not illustrated in FIG. 3 for clarity.

The Ethernet MAC interface circuitry 304 may operate at the lower half of the data link layer of the seven-layer Open Systems Interconnect model and provide network access. The Ethernet MAC interface circuitry 304 may assemble and initiate packets for transmission. The PHY 302 may provide a physical interface to the communications link 176 any may have a physical medium dependent layer that depends on the physical media of the link 176. The PHY 302 may also have a physical medium independent layer coupled via an interface to the physical medium dependent layer.

The IC 160 may also include two buffers 306 and 308 for low and high priority packets respectively. The IC 160 may transmit a low priority packet from the buffer 306 that stores low priority packets if no packet is available in the buffer 308 for high priority packets. The IC 160 may interrupt transmission of the low priority packet upon notice of one or more high priority packets available for transmission. Such high priority packets may be stored in the buffer 308 and the IC 160 may empty the buffer 308 of all the high priority packets while the low priority packet is interrupted.

On the receiving side, the IC 162 may also have Ethernet MAC interface circuitry 316 and PHY 310 and two assembling buffers 312 and 314 for low and high priority packets respectively. The Ethernet MAC interface circuitry 316 may receive packets from the PHY 310 and perform various operations on received packets such as parsing of the packets into various fields, performing error detection calculations, and storing of any truncated low priority packet in the buffer 312 while waiting for the remainder of the low priority packet to be transmitted. The two assembling buffers 312 and 314 on the receiving side for low and high priority packets respectively ensure that there may be only one low priority truncated packet in the assembling buffer 312 since the transmitted low priority packet may only be interrupted when there are high priority packets available from the buffer 308.

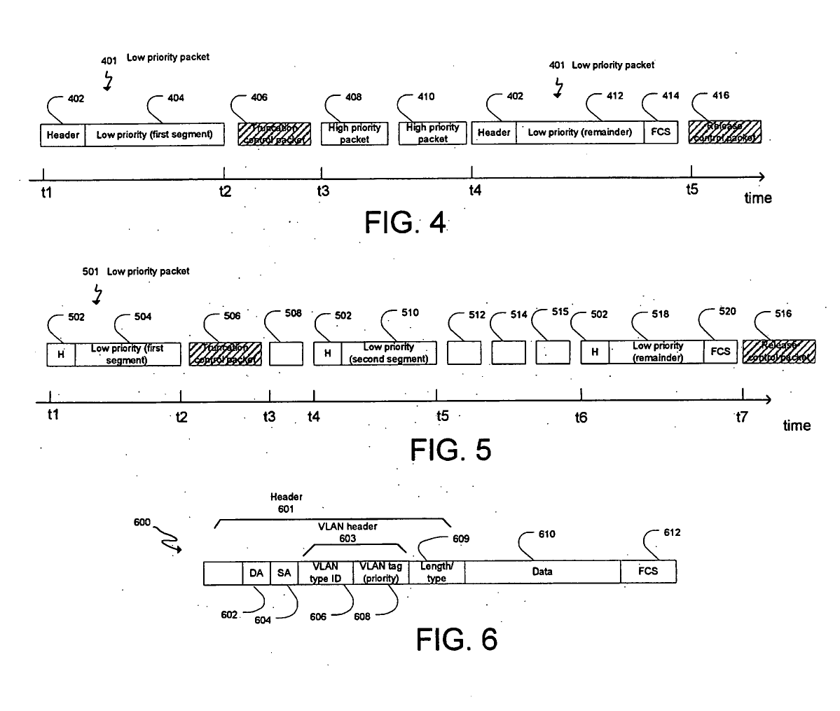

FIG. 4 illustrates transmission of a low priority packet 401 which may be interrupted to transmit one or more high priority packets 408, 410 that become available for transmission. The Ethernet MAC interface circuitry 304 of the IC 160 may determine that the packet 401 is a low priority packet and may temporarily store the low priority packet 401 in the buffer 306 for low priority packets. At time t1, the IC 160 may start to transmit the low priority packet 401 if the buffer 308 for high priority packets is empty.

The low priority packet 401 may be compliant with the Ethernet communication protocol and may have a size ranging from 63 bytes to 1,518 bytes. In some instances having jumbo packet support, the low priority packet 401 may be as large as 9 kilobytes.

The IC 160 may have transmitted a first segment 404 of the low priority packet 401 including the header 402 of the packet 401, when at time t2 two high priority packets 408 and 410 become available in the buffer 308 for transmission. Rather than wait for the entirety of the low priority packet 401 to be transmitted, the IC 160 may interrupt transmission of the low priority packet 401. To notify the receiving node that the low priority packet 401 has been interrupted, the IC 160 may transmit a truncation control packet 406. The receiving Ethernet MAC interface circuitry 316 may then hold the first segment 404 of the low priority packet 401 in the buffer 312 while it waits for the remainder of the packet 401.

At time t3, the IC 160 may then start to transmit the high priority packets 408, 410 in their entirety. One or more high priority packets may be transmitted while the low priority packet 401 is interrupted. The high priority packets 408, 410 may also be compliant with the Ethernet communication protocol. Once the buffer 308 has been emptied of all the high priority packets 408, 410, the IC 160 may then continue with transmission of the low priority packet 401 at time t4. The IC 160 may resend the header 402 of the low priority packet 401 with a remaining segment 412 of the low priority packet. The remaining segment may also include a frame check sequence (FCS) 414. The FCS 414 may consist of a cyclic redundancy check (CRC) value which may be created by the transmitting Ethernet MAC interface circuitry 304 and which may be recalculated by the receiving Ethernet MAC interface circuitry 316 to check for damaged packets. Once the entirety of the low priority packet 401 has been transmitted, the IC 160 may transmit a release control packet 416 to provide an indication to the receiving node of transmission of the entirety of the low priority packet 401.

The truncation control packet 406 and the release control packet 416 may be somewhat similar in structure to a pause control packet, as defined in the IEEE 802.3 Standard (clause 31.4.1), that signals a transmitting node to pause transmission of additional data packets. In particular, the truncation control packet 406 and release control packet 416 may each have a destination address field, source address field, length/type field, and MAC control opcode field to name several fields of such packets. The length/type field of the truncation control packet 406 and the release control packet 416 may differ from each other and from the standard value used for a pause control packet to signal the respective type of truncation or release control packet. In addition, the MAC control opcode field may have a different operation code for the truncation and the release control packet that may indicate the MAC control function to be provided by the receiving node, e.g., to hold a portion of the low priority packet in the buffer 312. while waiting for the remainder of the packet 401 in response to the truncation control packet 406 or to release the low priority packet from the buffer 312 in response to the release control packet 416 indicating transmission of the entirety, of the low priority packet 401

In another instance, the Ethernet MAC interface circuitry 304 may transmit an entirety of a low priority packet without interruption if no high priority packets are available for transmission during that time. In this situation, if the transmitting Ethernet MAC interface circuitry 304 has no additional packets to transmit after transmission of a low priority packet that has not been truncated, it may transmit the release control packet 416 indicating the previous packet contained the entirety of that packet. If the transmitting Ethernet MAC interface circuitry 304 has additional packets to transmit after transmission. of the low priority packet that has not been truncated, it may transmit such additional packets without transmission of the release control packet 416.

Therefore, if the receiving Ethernet MAC interface circuitry 316 receives a portion of a low priority packet, it will assume it is the entire low priority packet if it receives another packet without having received a truncated control packet indicating that the packet has been truncated. If the receiving Ethernet MAC interface circuitry 316 receives a portion of a low priority packet, it may also assume it has received the entire low priority packet if it receives a release control packet after the portion of the low priority packet.

FIG. 5 also illustrates transmission of a low priority packet 501 which may be interrupted multiple times to transmit a plurality of high priority packets that become available for transmission during transmission of the low priority packet 501. At time t2, the IC 160 may interrupt transmission of the low priority packet 501 when the high priority packet 508 becomes available for transmission, and may notify the receiving node of this interruption by transmission of the truncation packet 506. The IC 160 may then transmit the high priority packet 508 in its entirety. All packets of FIG. 5 may comply with the Ethernet communication protocol. The IC 160 may then continue to send the low priority packet 501 and may send the header portion 502 of the low priority packet 501 again with a second segment 510 of the low priority packet 501 before an additional interruption of the low priority packet 501 at time t5. The IC 160 may then transmit high priority packets 512, 514, and 515 during this second interruption of the low priority packet 501.

Once the buffer 308 has been emptied of all the high priority packets 512, 514, and 515, the IC 160 may then continue with transmission of the low priority packet 501 at time t6. The IC 160 may resend the header 502 of the low priority packet 501 with a remaining segment 518 of the low priority packet 501. The remaining segment may also include the FCS 520. Finally, the IC 160 -may transmit the release control packet 516 at time t7 to provide an indication to the receiving node of transmission of the entirety of the low priority packet 501.

FIG. 6 illustrates a packet 600 generally including a header 601, data field 610, and FCS 612. A virtual local area network (VLAN) header 603 may be inserted into the header 601 between the source address (SA) field 604 and length/type field 609 to assist with specifying and identifying a priority level for each packet. The VLAN header 603 may comply or be compatible with the IEEE 802.1Q Standard entitled “Virtual Bridged Local Area Networks,” published May, 2003 and/or later versions of this Standard. The header 601 may contain other fields such as the destination address (DA) field 602.

The VLAN header 603 may include a VLAN type ID field 606 and a VLAN tag field 608. The VLAN type ID field 606 indicates that the packet is a VLAN packet. The VLAN tag field 608 may contain transmission priority information. The VLAN tag field may comply or be compatible with the IEEE 802.1Q Standard. There may be eight transmission priority levels (levels 0-7) specified in a three bit field as detailed by the IEEE 802.1 Q Standard, where 7 is the highest priority and 0 is the lowest priority. In one embodiment, priority levels 0-5 may be designated as low priority levels and priority levels 5-7 may be designated as high priority levels.

Some examples of high priority traffic may include, but not be limited to, real time voice traffic, video traffic, and network critical traffic. Another example of a high priority packet may be a pause control packet sent to a node currently transmitting packets to instruct that node to stop transmitting any additional packets. Such a pause control packet may be sent in response to a congestion condition. As used herein, a “congestion condition” may be an excessive accumulation of packets. Such a congestion condition may be detected in a variety of ways including a particular buffer of the node that stores at least a portion of the incoming packets reaching a full threshold level.

The IC 160 may utilize the VLAN tag 608 field of the packet to determine priority. If the VLAN tag 608 field indicates a high priority packet, then all such high priority packets may be queued into the buffer 308. This ensures that there at most there may be only one low priority packet that is in a truncated state. When the VLAN tag is utilized to specify and identify priority levels of each packet, a system implementation may restrict itself to VLAN tag aware nodes to ensure that the nodes can distinguish low and high priority packets utilizing the VLAN tags.

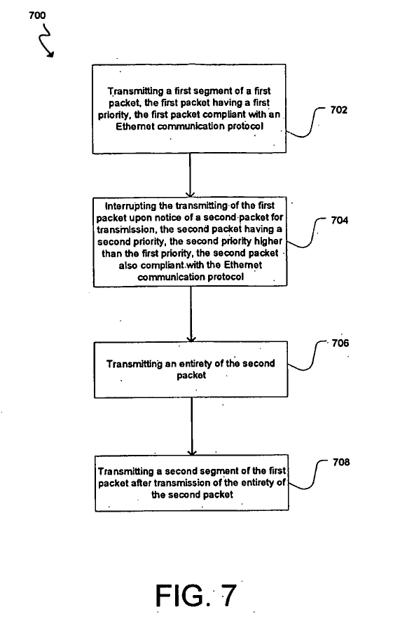

FIG. 7 is a flow chart of operations 700 consistent with an embodiment. Operation 702 may include transmitting a first segment of a first packet, the first packet having a first priority, the first packet compliant with an Ethernet communication protocol. Operation 704 may include interrupting the transmitting of the first packet upon notice of a second packet for transmission, the second packet having a second priority, the second priority higher than the first priority, the second packet also compliant with the Ethernet communication protocol. Operation 706 may include transmitting an entirety of the second packet. Finally, operation 708 may include transmitting a second segment of the first packet after transmission of the entirety of the second packet.

It will be appreciated that the functionality described for all the embodiments described herein, may be implemented using hardware, firmware, software, or a combination thereof.

Thus, in summary, one embodiment may comprise an apparatus. The apparatus may comprise an integrated circuit capable of transmitting a first segment of a first packet, the first packet having a first priority, the first packet compliant with an Ethernet communication protocol. The integrated circuit may also be capable of interrupting the transmitting of the first packet upon notice of a second packet for transmission, the second packet having a second priority, the second priority higher than the first priority, the second packet also compliant with the Ethernet communication protocol. The integrated circuit may also be capable of transmitting an entirety of the second packet. Finally, the integrated circuit may also be capable of transmitting a second segment of the first packet after transmission of the entirety of the second packet.

Another embodiment may comprise an article. The article may comprise a storage medium having stored thereon instructions that when executed by a machine result in the following: transmitting a first segment of a first packet, the first packet having a first priority, the first packet compliant with an Ethernet communication protocol; interrupting the transmitting of the first packet upon notice of a second packet for transmission, the second packet having a second priority, the second priority higher than the first priority, the second packet also compliant with the Ethernet communication protocol; transmitting an entirety of the second packet; and transmitting a second segment of the first packet after transmission of the entirety of the second packet.

A system embodiment may comprise a network interface card comprising an integrated circuit. The network interface card may be capable of being coupled to a bus. The integrated circuit may also be capable of transmitting a first segment of a first packet, the first packet having a first priority, the first packet compliant with an Ethernet communication protocol. The integrated circuit may also be capable of interrupting the transmitting of the first packet upon notice of a second packet for transmission, the second packet having a second priority, the second priority higher than the first priority, the second packet also compliant with the Ethernet communication protocol. The integrated circuit may also be capable of transmitting an entirety of the second packet. Finally, the integrated circuit may also be capable of transmitting a second segment of the first packet after transmission of the entirety of the second packet.

Advantageously, in these embodiments, a low priority Ethernet packet may be interrupted upon notice of a high priority packet enabling the high priority packet or packets to be quickly transmitted; In this way, end-to-end latency for high priority traffic can be reduced compared to a conventional method that transmits the entirety of the low priority packet before transmitting the high priority packet. Furthermore, as the length of the low priority Ethernet packets can be as high as 1,518 bytes to 9 kilobytes, the latency improvements may be substantial since the high priority packets do not have to wait for transmission of the entire large low priority frame. This may then lead to improved quality of service for high priority traffic on Ethernet networks.

In addition, a pause control packet that may be sent in response to a detection of a congestion condition may be considered a high priority packet. Therefore, if a low priority packet is currently being transmitted, its transmission may be interrupted enabling the transmission of the pause control packet. In this way, the ability to respond to congestion events may be improved compared to a conventional method that would need to wait for completion of transmission of the low priority packet before transmitting the pause control packet.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method comprising:
transmitting a first segment of a first packet, said first packet having a first priority, said first packet compliant with an Ethernet communication protocol;
interrupting said transmitting of said first packet upon notice of a second packet for transmission, said second packet having a second priority, said second priority higher than said first priority, said second packet also compliant with said Ethernet communication protocol;
transmitting an entirety of said second packet; and
transmitting a second segment of said first packet after transmission of said entirety of said second packet.

2. The method of claim 1, wherein said first priority is defined in a virtual local area network (VLAN) tag of said first packet and said second priority is defined in a VLAN tag of said second packet.

3. The method of claim 1, further comprising transmitting a truncation control packet in response to said interrupting of said first packet, said truncation control packet providing an indication to a receiving node of said interrupting of said first packet.

4. The method of claim 3, wherein said second segment of said first packet comprises a remainder of an entirety of said first packet, and wherein said method further comprises transmitting a release control packet in response to transmission of said remainder of said entirety of said first packet, said release control packet providing an indication to said receiving node of a transmission of said entirety of said first packet.

5. The method of claim 4, wherein said receiving node comprises a first buffer and a second buffer, said first buffer capable of holding said first packet until receipt of said release packet, said second buffer capable of holding said second packet.

6. The method of claim 1, wherein said second segment of said first packet comprises a portion of said first packet, and said method further comprises:
interrupting said transmitting of said first packet again upon notice of a third packet for transmission, said third packet having a third priority, said third priority higher than said first priority, said third packet also compliant with said Ethernet communication protocol;
transmitting an entirety of said third packet; and
transmitting a third segment of said first packet after transmission of said entirety of said third packet.

7. The method of claim 1, wherein said second packet comprises a pause control packet, said pause control packet transmitted to a node in response to a congestion condition, said pause control packet providing instruction to said node to pause transmission of additional packets.

8. An apparatus comprising:
an integrated circuit capable of transmitting a first segment of a first packet, said first packet having a first priority, said first packet compliant with an Ethernet communication protocol, said integrated circuit also capable of interrupting said transmitting of said first packet upon notice of a second packet for transmission, said second packet having a second priority, said second priority higher than said first priority, said second packet also compliant with said Ethernet communication protocol, said integrated circuit also capable of transmitting an entirety of said second packet, and said integrated circuit also capable of transmitting a second segment of said first packet after transmission of said entirety of said second packet.

9. The apparatus of claim 8, wherein said first priority is defined in a virtual local area network (VLAN) tag of said first packet and said second priority is defined in a VLAN tag of said second packet.

10. The apparatus of claim 8, wherein said integrated circuit is further capable of transmitting a truncation control packet in response to said interrupting of said first packet, said truncation control packet providing an indication to a receiving node of said interrupting of said first packet.

11. The apparatus of claim 10, wherein said second segment of said first packet comprises a remainder of an entirety of said first packet, and wherein said integrated circuit is further capable of transmitting a release control packet in response to transmission of said remainder of said entirety of said first packet, said release control packet providing an indication to said receiving node of a transmission of said entirety of said first packet.

12. The apparatus of claim 11, wherein said second segment of said first packet comprises a portion of said first packet, and wherein said integrated circuit is further capable of interrupting said transmitting of said first packet again upon notice of a third packet for transmission, said third packet having a third priority, said third priority higher than said first priority, said third packet also compliant with said Ethernet communication protocol, said integrated circuit further capable of transmitting an entirety of said third packet, and said integrated circuit further capable of transmitting a third segment of said first packet after transmission of said entirety of said third packet.

13. The apparatus of claim 8, wherein said first packet is stored in a first buffer for low priority packets and said second packet is stored in a second buffer for high priority packets, said integrated circuit capable of emptying said second buffer of all said high priority packets during said interrupting of said transmitting of said first packet.

14. An article comprising:
a storage medium having stored thereon instructions that when executed by a machine result in the following:
transmitting a first segment of a first packet, said first packet having a first priority, said first packet compliant with an Ethernet communication protocol;
interrupting said transmitting of said first packet upon notice of a second packet for transmission, said second packet having a second priority, said second priority higher than said first priority, said second packet also compliant with said Ethernet communication protocol;
transmitting an entirety of said second packet; and
transmitting a second segment of said first packet after transmission of said entirety of said second packet.

15. The article of claim 14, wherein said instructions that when executed by said machine also result in transmitting a truncation control packet in response to said interrupting of said first packet, said truncation control packet providing an indication to a receiving node of said interrupting of said first packet.

16. The article of claim 15, wherein said second segment of said first packet comprises a remainder of an entirety of said first packet, and wherein said instructions that when executed by said machine also result in transmitting a release control packet in response to transmission of said remainder of said entirety of said first packet, said release control packet providing an indication to said receiving node of a transmission of said entirety of said first packet.

17. A system comprising:
a network interface card comprising an integrated circuit, said network interface card capable of being coupled to a bus, said integrated circuit capable of transmitting a first segment of a first packet, said first packet having a first priority, said first packet compliant with an Ethernet communication protocol, said integrated circuit also capable of interrupting said transmitting of said first packet upon notice of a second packet for transmission, said second packet having a second priority, said second priority higher than said first priority, said second packet also compliant with said Ethernet communication protocol, said integrated circuit also capable of transmitting an entirety of said second packet, and said integrated circuit also capable of transmitting a second segment of said first packet after transmission of said entirety of said second packet.

18. The system of claim 17, further comprising a circuit board comprising said bus and a bus interface slot, said network interface card capable of being coupled to said bus interface slot.

19. The system of claim 17, wherein said integrated circuit is further capable of transmitting a truncation control packet in response to said interrupting of said first packet, said truncation control packet providing an indication to a receiving node of said interrupting of said first packet.

20. The system of claim 17, wherein said second segment of said first packet comprises a remainder of an entirety of said first packet, and wherein said integrated circuit is further capable of transmitting a release control packet in response to transmission of said remainder of said entirety of said first packet, said release control packet providing an indication to said receiving node of a transmission of said entirety of said first packet.

21. The system of claim 17, wherein said network interface card further comprises a first buffer capable of storing, a first plurality of packets, said first plurality of packets including said first packet, said network interface card further comprising a second buffer capable of storing a second plurality of packets, said second plurality of packets including said second packet, and each of said second plurality of packets having a higher priority than each of said first plurality of packets, said integrated circuit capable of emptying said second buffer of all of said second plurality of packets during said interrupting of said transmitting of said first packet.
